(19) United States
(12) Patent Application Publication
(10) Pub. No.: US 2015/0190942 A1
(43) Pub. Date: Jul. 9, 2015

(54) CUTTING DIE WITH RETENTION FEATURE

(71) Applicant: Phantom Frames Inc., Santa Ana, CA (US)

(72) Inventors: Forrest Smith, Santa Ana, CA (US); Kenneth Spaulding, Orange, CA (US); Edward Tansingco, Santa Ana, CA (US)

(73) Assignee: Phantom Frames Inc., Santa Ana, CA (US)

(21) Appl. No.: 14/150,946

(22) Filed: Jan. 9, 2014

(51) Int. Cl. B26F 1/44

(52) U.S. Cl. CPC B26F 1/44; B26F 2001/4463

(57) ABSTRACT

A steel rule die has a die base of deformable material with a slit cut therein. A steel rule forms a die punch having a base portion insertable into the slit. Spaced projections are arranged around an outer face said base portion such that upon insertion of the die punch into the slit the projections extend into locking engagement with the die base to inhibit extraction of the die punch from the die base.

### FIELD OF THE INVENTION

This invention relates to the manufacture of steel rule dies for use in cutting sheet materials, including paper, cardboard, rubber and plastic. In particular, the invention relates to improved methods and designs for affixing punches to the plywood core of steel rule dies.

### BACKGROUND OF THE INVENTION

Steel-rule dies, also known as cookie-cutter dies, are used to cut sheet metal and softer webs, such as plastics, wood, cork, felt, fabrics, cardboard, and paperboard. Steel rule die cutting has been used for many years to create most cardboard boxes and packages.

The cutting surface of the die is the edge of hardened steel strips, known as steel rule. These steel rules are usually located using saw or laser-cut slits in a die base. The die base is usually constructed of high-grade and high-density plywood. This plywood is composed of hardwoods and is free from voids or other imperfections. The plywood is either flat for flat bed die presses or semi-circular for rotary die presses. A specialized bandsaw or laser cutter is used to cut precisely positioned slits into the plywood. Steel rules are inserted into these slits.

The steel rule is essentially an elongated razor blade made from hardened steel. It may take many shapes to form a punch. The shape of the punch depends on the nature of the cuts to be made. For example, for cutting out circular holes, it will be cylindrical, with the base of the cylinder inserted into the plywood. The die-maker cuts and bends the steel rule into the shape of the punch before press fitting it into the slits made in the plywood. Rubber pads are attached to the plywood to help eject the material after it is cut. The rubber pads compress on the downstroke and expand on the upstroke to push the workpiece out of the die.

There are many different cutting punches used in the die cutting process. These punches are used to cut out holes of different shapes in a die cut piece. The punches are usually hammered into the plywood of the steel rule die by the die-maker. These punches are generally held in place by a press-fit. Over time, the punches wear away the wood holding them in place, become loose, and fall out of the die. This means that the die base has to be replaced or repaired to remount the punch, which is a time-consuming operation.

### SUMMARY OF INVENTION

Embodiments of the invention provide an improved design of a punch for a steel rule die where the outer perimeter of the punch has one or more protrusions (which act like the barbs on a fish hook). When the punch is pressed or force fitted into the steel rule die, the wood in which the punch is pressed expands back to its original shape over the one or more protrusions locking the punch into place on the steel rule die. Water can be used to help the wood expand.

According to the present invention there is provided a steel rule die comprising a die base of deformable material having a slit cut therein; a steel rule forming a die punch having a base portion insertable into said slit; and spaced projections arranged around an outer face said base portion such that upon insertion of said die punch into said slit said projections extend into locking engagement with the die base to inhibit extraction of the die punch from the slit.

The protrusion may comprise spaced projections cut out of the wall of the steel rule, or alternatively it make take the form of a material added to the wall of the steel rule. The projections

In another aspect the invention provides a die punch for a steel rule die comprising a base portion insertable into a slit formed in a die base of deformable material; and spaced projections arranged around an outer face said base portion such that upon insertion of said die punch into said slit said projections extend into locking engagement with the die base to inhibit extraction of the die punch from the slit.

In yet another aspect the invention provides a method of locating a steel rule in a steel rule die comprising providing a die base of deformable material having a slit cut therein; providing a die punch with spaced projections arranged around an outer face said base portion such; and inserting said die punch into said base portion such that upon insertion of said punch into said slit said projections extend into locking engagement with the die base to inhibit extraction of the die punch from the die base.

The projections may be evenly circumferentially spaced around the die punch, which may have any suitable shape such as cylindrical, elliptical, triangular, rectangular, square, etc.

### BRIEF DESCRIPTION OF THE DRAWINGS

The invention will now be described in more detail, by way of example only, with reference to the accompanying drawings, in which:—

FIGS. 1a-1c are respectively plan, perspective and side views of a die punch in accordance with an embodiment of the invention;

FIGS. 2a-2c are respectively plan, perspective and side views of a die punch of square shape;

FIGS. 3a-3c are respectively plan, perspective and side views of a die punch with beaded welds; and

FIG. 4 is a plan view of a plywood die base.

### DETAILED DESCRIPTION OF EMBODIMENTS OF THE INVENTION

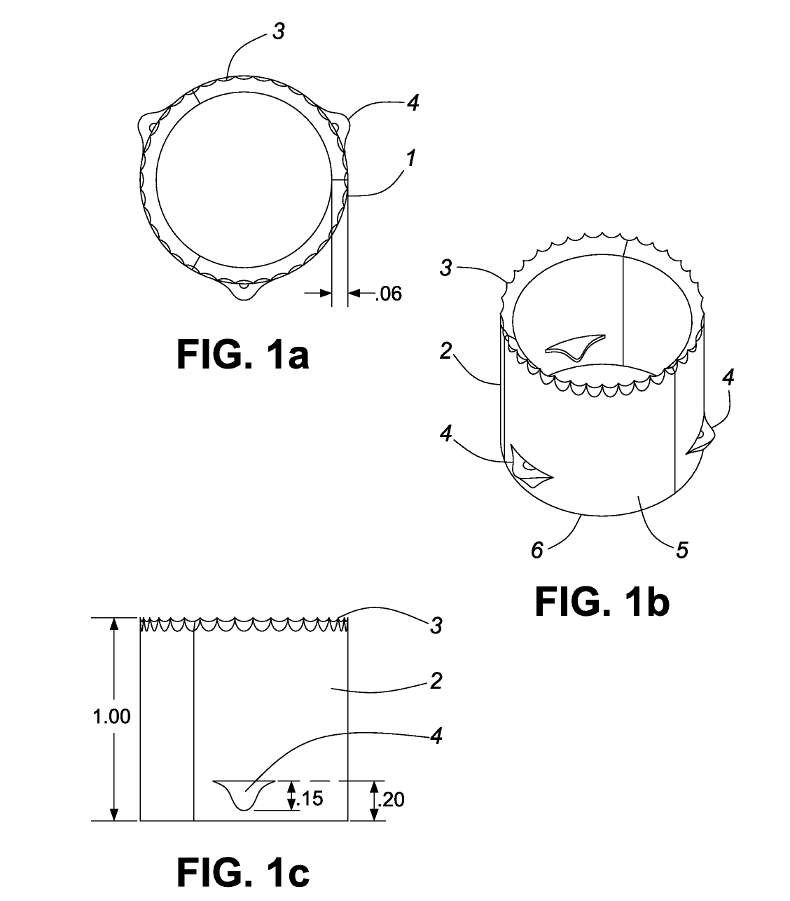

The steel rule die punch 1 shown in FIGS. 1a-1c is generally cylindrical for cutting circular holes in cardboard, paperboard and the like. It will be appreciated that the die punch 1 can have any desired shape, such as cylindrical, elliptical, triangular, rectangular, square, etc. in the manner of a cookie cutter. The dimensions in the drawings are shown in inches.

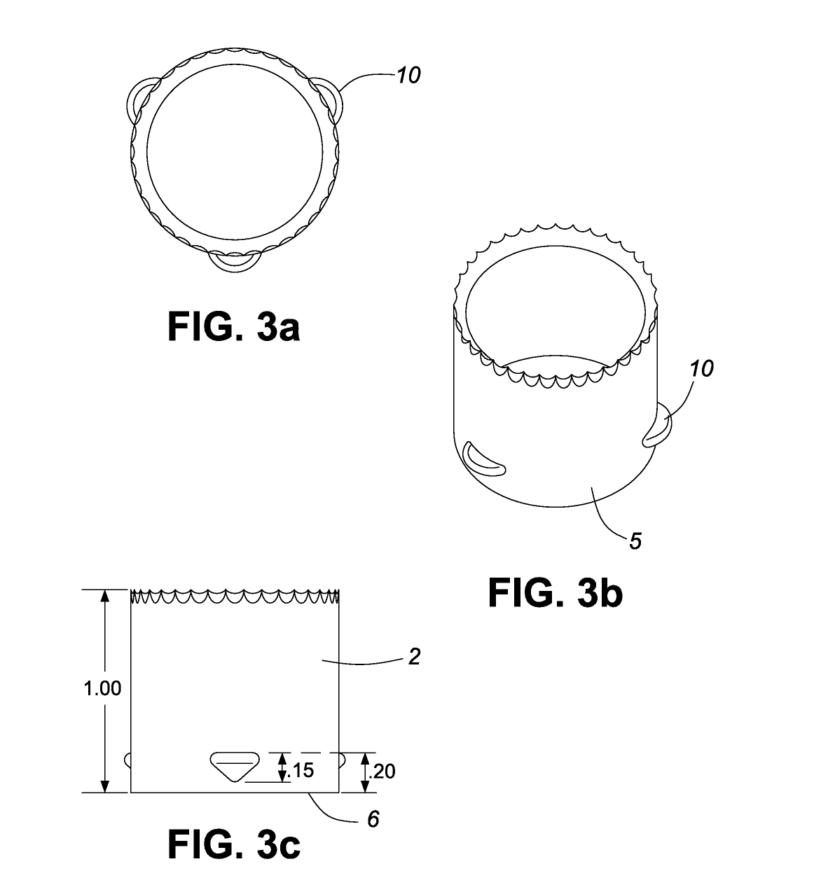

The die punch 1 in this non-limiting example comprises a cylindrical wall 2 of steel or other suitable material with a razor-like serrated cutting edge 3 at one end. Evenly circumferentially spaced triangular projections 4 extending around a base portion 5 of the outer face of the wall 2 are cut and pressed out of the wall 2 of the die punch 1. The lower edge 6 of the punch 1 is smooth and designed such that the base portion 5 fits in a matching slit in a plywood die base 8 shown in FIG. 3.

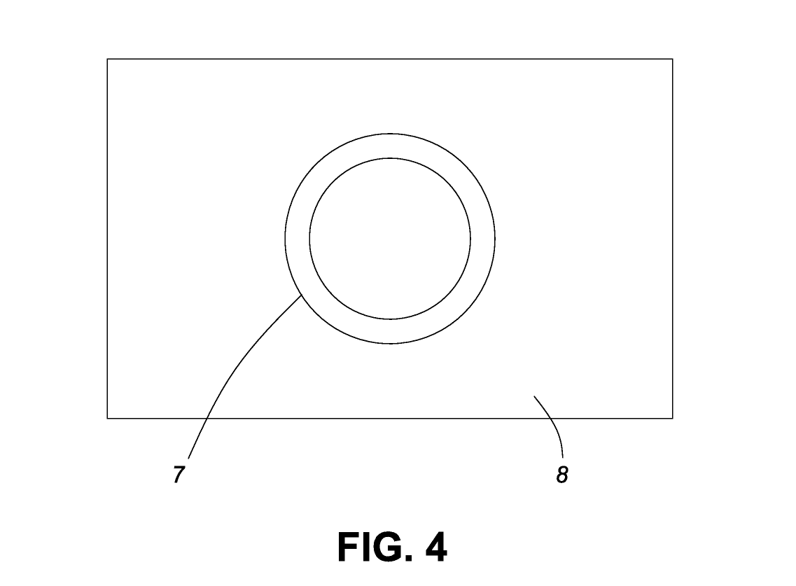

A die base 8 is shown in FIG. 4. The die base 8 is made of a deformable material, which in this example is plywood, with a slit circular 7 cut therein for receiving the lower edge 6 the die punch 1, which in this case is presumed to be cylindrical. Of course, for a square die punch the slit 7 will be square. The slit 7 may typically be cut with a laser or saw to the desired shape. The base 8 may be flat or rounded if it is to be used in a rotary press.

To use the die punch, the base of the die punch 1 is inserted into the slit 7 in the die base 8. As the base 5 is force-fitted into the slit 7, the wood of the die base 8 gives or deforms around the projections 4 to allow the base of the punch to be fitted into the slit 7. The wood then naturally springs back over the projections 4. When an attempt is made to extract the punch 1 from the slit 8, the projections 4 lockingly engage into the walls of the slit in the manner of a barb on a fish-hook thus inhibiting extraction. If desired the wood can be wet to facilitate insertion of the steel rule die into the die base 8. There may also be some resilience in the projections themselves due to the natural springiness of the steel forming the wall of the punch, which facilitates insertion into the slit.

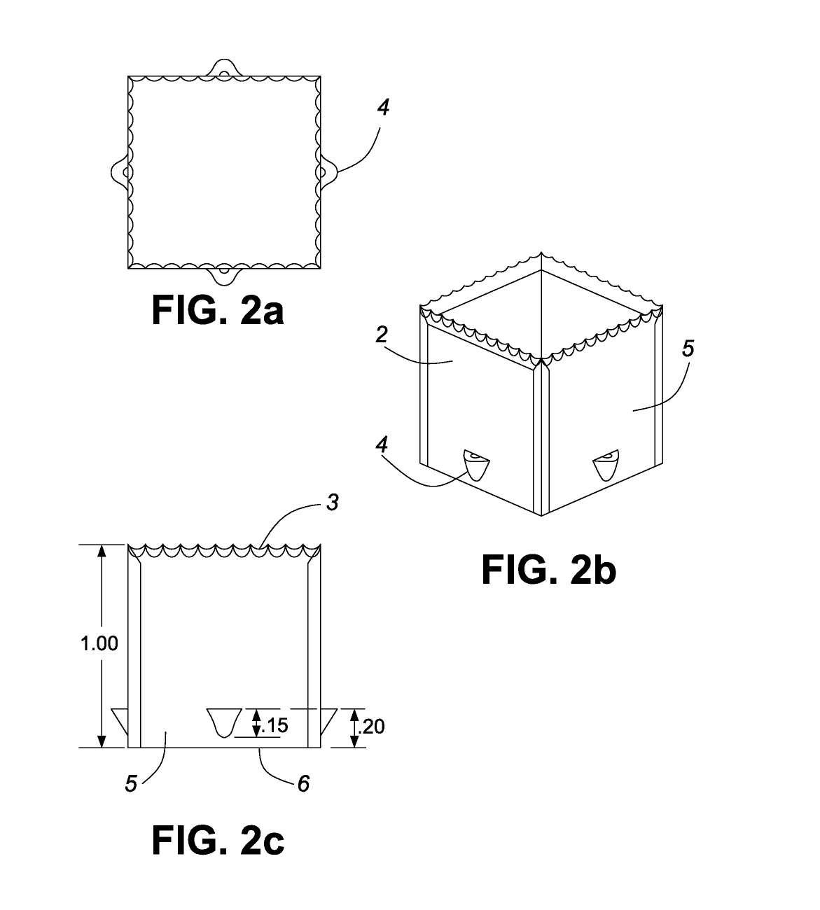

FIGS. 2a to 2c show an example of the die punch, which is square in cross section. It otherwise has a similar construction to the embodiment shown in FIGS. 1a to 1c.

An alternative embodiment shown in FIGS. 3a to 3c has projections 10 in the form small beads that welded onto the wall 2 of the die punch. The weld is shown of generally triangular shape similar to that in the first embodiment, but it could also have other shapes such as a tear-drop shape. The welded beads look like small lugs or ears protruding from the wall of the die punch. The could also be made of solder or some other suitable material.

The steel rule die in accordance with embodiments of the invention is generally used in a manner familiar to one skilled in the art. The barb-like protrusions however significantly improve the performance and longevity by preventing the punches from falling out of the die base.

In order to test the effectiveness of the invention, a series of tests were carried out on standard non-barbed punches and punches containing projections 4 similar to those shown in FIGS. 1a-1c.

The results are shown in the table below.

| | Standard | Barbed | % Increased |
|---|---|---|---|
| | Punch | Punch | Force |
| Wood Specimen 1 | 2150 | 6405 | 198% |
| Wood Specimen 2 | 1516 | 5733 | 278% |
| Wood Specimen 3 | 1750 | 6725 | 284% |
| Wood Specimen 4 | 1873 | 7124 | 280% |
| Wood Specimen 5 | 2013 | 6145 | 205% |
| Wood Specimen 6 | 1919 | 6519 | 240% |

Readings are in OZ. of compression force

It will be seen that there is a dramatic increase in the force required to remove the punch from the die base when the projections are employed in accordance with the invention as compared with a standard punch. This translates into improved performance during use since the punches remain in place for longer and the die base does not need to be replaced so often.

1. A steel rule die comprising:
a die base of deformable material having a slit cut therein;
a steel rule forming a die punch having a base portion insertable into said slit; and
spaced projections arranged around an outer face said base portion such that upon insertion of said die punch into said slit said projections extend into locking engagement with the die base to inhibit extraction of the die punch from the slit.

2. A steel rule die as claimed in claim 1, wherein said spaced projections are cut out of a wall of the die punch.

3. A steel rule die as claimed in claim 1, wherein said spaced projections are generally triangular.

4. A steel rule die as claimed in claim 1, wherein said spaced projections are evenly spaced around the base of the die punch.

5. A steel rule die as claimed in claim 1, wherein said die punch is cylindrical.

6. A steel rule die as claimed in claim 1, wherein said spaced projections are in the form of beads attached to the base of the die punch.

7. A steel rule die as claimed in claim 6, wherein said beads are welded to the base of the die punch.

8. A die punch for a steel rule die comprising:
a base portion insertable into a slit formed in a die base of deformable material; and
spaced projections arranged around an outer face said base portion such that upon insertion of said die punch into said slit said projections extend into locking engagement with the die base to inhibit extraction of the die punch from the slit.

9. A die punch as claimed in claim 8, wherein said spaced projections are cut out of a wall of the die punch.

10. A die punch as claimed in claim 8, wherein said spaced projections are generally triangular.

11. A die punch as claimed in claim 8, wherein said spaced projections are evenly spaced around the base of the die punch.

12. A die punch as claimed in claim 8, wherein said die punch is cylindrical.

13. A die punch as claimed in claim 8, wherein said spaced projections are in the form of beads attached to the base of the die punch.

14. A die punch as claimed in claim 13, wherein said beads are welded to the base of the die punch.

15. A method of locating a steel rule in a steel rule die comprising:
providing a die base of deformable material having a slit cut therein;
providing a die punch with spaced projections arranged around an outer face said base portion such; and
inserting said die punch into said base portion such that upon insertion of said punch into said slit said projections extend into locking engagement with the die base to inhibit extraction of the die punch from the die base.

16. A method as claimed in claim 15, wherein said spaced projections are cut out of the wall of the steel rule.

17. A method as claimed in claim 16, wherein said spaced projections are generally triangular.

18. A method as claimed in claim 14, wherein said spaced projections comprise beads attached to the base of the die punch.

19. A method as claimed in claim 18, wherein said beads are welded to the base of the die punch.
